(19) United States
(12) Patent Application Publication
(10) Pub. No.: US 2024/0236778 A1
(43) Pub. Date: Jul. 11, 2024

(54) METHODS AND APPARATUSES FOR A PRIMARY SECONDARY CELL (PSCELL) ADDITION OR CHANGE PROCEDURE

(71) Applicant: LENOVO (BEIJING) LIMITED, Beijing (CN)

(72) Inventors: Congchi ZHANG, Shanghai (CN); Lianhai WU, Beijing (CN); Mingzeng DAI, Shanghai (CN); Le YAN, Shanghai (CN)

(21) Appl. No.: 18/562,002

(22) PCT Filed: May 18, 2021
(86) PCT No.: PCT/CN2021/094405

§ 371 Date: Nov. 17, 2023

(51) Int. Cl. H04W 36/00

(52) U.S. Cl. CPC H04W 36/0069; H04W 36/0072; H04W 36/0079; H04W 36/00835

(57) ABSTRACT

Embodiments of the present application relate to methods and apparatuses for a primary secondary cell (PSCell) addition procedure or a PSCell change procedure considering a deactivated state of a secondary cell group (SCG) associated with a PSCell in a multi-radio dual connectivity (MR-DC) scenario under a 3rd Generation Partnership Project (3GPP) 5G system or the like. According to an embodiment of the present application, a method may be performed by a UE and can include: receiving configuration information from a network, wherein the configuration information is associated with a PSCell addition procedure or a PSCell change procedure for a SCG; determining whether the PSCell addition procedure or the PSCell change procedure is successfully completed when the SCG is in a deactivated state; and in response to determining that the PSCell addition procedure or the PSCell change procedure has failed, transmitting failure information to the network.

### TECHNICAL FIELD

Embodiments of the present application generally relate to wireless communication technology, especially to methods and apparatuses for a primary secondary cell (PSCell) addition procedure or a PSCell change procedure considering a deactivated state of a secondary cell group (SCG) associated with a PSCell in a multi-radio dual connectivity (MR-DC) scenario.

### BACKGROUND

Next generation radio access network (NG-RAN) supports a MR-DC operation. In the MR-DC operation, a user equipment (UE) with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as a master node (MN), and the other node may act as a secondary node (SN). The MN and SN are connected via a network interface (for example, Xn interface as specified in 3rd Generation Partnership Project (3GPP) standard documents), and at least the MN is connected to the core network.

In a 3GPP 5G system or network, a SCG associated with a PSCell may be in an activated state or a deactivated state. However, details regarding handling a PSCell addition procedure or a PSCell change procedure considering a deactivated state of a SCG associated with a PSCell in a MR-DC scenario have not been discussed in 3GPP 5G technology yet.

### SUMMARY

Some embodiments of the present application provide a method for wireless communications. The method may be performed by a UE. The method includes: receiving configuration information from a network, wherein the configuration information is associated with a PSCell addition procedure or a PSCell change procedure for a SCG; determining whether the PSCell addition procedure or the PSCell change procedure is successfully completed when the SCG is in a deactivated state; and in response to determining that the PSCell addition procedure or the PSCell change procedure has failed, transmitting failure information to the network.

Some embodiments of the present application also provide a UE. The UE includes a processor and a wireless transceiver coupled to the processor; and the processor is configured: to receive, via the wireless transceiver, configuration information from a network, wherein the configuration information is associated with a PSCell addition procedure or a PSCell change procedure for a SCG; to determine whether the PSCell addition procedure or the PSCell change procedure is successfully completed when the SCG is in a deactivated state; and in response to determining that the PSCell addition procedure or the PSCell change procedure has failed, to transmit failure information to the network via the wireless transceiver.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE.

Some embodiments of the present application provide a further method for wireless communications. The method may be performed by a network device (e.g., a MN and/or a SN). The method includes: transmitting configuration information to a UE, wherein the configuration information is associated with a PSCell addition procedure or a PSCell change procedure for a SCG; and in response to receiving failure information from the UE when the SCG is in a deactivated state, determining that the PSCell addition procedure or the PSCell change procedure has failed.

Some embodiments of the present application also provide a network device (e.g., a MN and/or a SN). The network device includes a processor and a wireless transceiver coupled to the processor; and the processor is configured: to transmit, via the wireless transceiver, configuration information to a UE, wherein the configuration information is associated with a PSCell addition procedure or a PSCell change procedure for a SCG; and in response to receiving, via the wireless transceiver, failure information from the UE when the SCG is in a deactivated state, to determine that the PSCell addition procedure or the PSCell change procedure has failed.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a network device (e.g., a MN and/or a SN).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flow chart for receiving configuration information associated with a PSCell addition procedure or a PSCell change procedure in accordance with some embodiments of the present application;

FIG. 3 illustrates an exemplary flow chart for transmitting configuration information associated with a PSCell addition procedure or a PSCell change procedure in accordance with some embodiments of the present application;

FIG. 4 illustrates an exemplary flow chart relating to configuration information associated with a PSCell addition procedure or a PSCell change procedure in accordance with some embodiments of the present application; and

FIG. 5 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

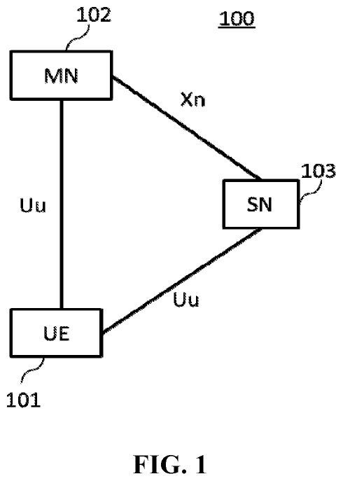

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a SCG. The SCG may refer to a group of serving cells associated with SN 103, and may include a primary secondary cell (PSCell) and optionally one or more SCells. The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to agreements of 3GPP standard documents, Release 17 work item on NR supports an efficient SCG activation or deactivation procedure in a MR-DC scenario. In an EN-DC deployment, power consumptions of a UE and a network are a big issue, due to maintaining two radio links simultaneously. In some cases, a power consumption of a NR UE is 3 to 4 times higher than that of a LTE UE. In an EN-DC deployment, a MN provides the basic coverage. When a UE's data rate requirement changes dynamically, e.g., from high to low, a SN is worth considering to be (de)activated to save energy consumptions of the network and the UE.

According to agreements of 3GPP standard documents, during following four procedures, a SCG associated with a target PSCell can be set to an activated state or a deactivated state.
(1) A PSCell addition procedure. This procedure may also be named as “a SCG addition procedure” or the like. During this procedure, a MN sends a SN addition request message (e.g., as specified in 3GPP standard document TS37.340) to one target SN, and the UE will be served by both the MN and the SN after completing the PSCell addition procedure.
(2) A conditional PSCell addition procedure. This procedure may also be named as “a conditional SCG addition procedure” or the like. During this procedure, a UE will be configured with multiple candidate target PSCells. These candidate target PSCells can be of the same SN or a different SN. Each PSCell in these candidate target PSCells is associated with an execution condition. A UE connects to a target PSCell once the corresponding execution condition is fulfilled. The target PSCell is one of the multiple candidate target PSCells. A candidate target PSCell may also be named as “a candidate PSCell” or the like.
(3) A PSCell change procedure. This procedure may also be named as “a SCG change procedure” or the like. During this procedure, there may be following four cases:
   a) A MN triggered intra-SN PSCell change case: a MN sends a SN modification request message (e.g., as specified in 3GPP standard document TS37.340) to the SN requesting change the PSCell.
   b) A MN triggered inter-SN PSCell change case: a MN sends a SN addition request message (e.g., as specified in 3GPP standard document TS37.340) to one target SN, and the MN releases the source SN once the target SN is added.
   c) A SN triggered intra-SN PSCell change case: a SN replaces the source PSCell with a target PSCell associated with the same SN.
   d) A SN triggered inter-SN PSCell change case: a source SN sends a SN modification required message (e.g., as specified in 3GPP standard document TS37.340) to a MN requesting a switch to a target SN.
(4) A conditional PSCell change procedure. This procedure may also be named as “a conditional SCG change procedure” or the like. During this procedure, a UE will be configured with multiple candidate target PSCells (which can be of the same SN or a different SN), each PSCell is associated with an execution condition, and a UE connects to the target PSCell (which is one of the multiple candidate target PSCells) once the corresponding execution condition is fulfilled. Then, the UE releases the connection with the source PSCell.

Currently, during a (conditional) PSCell addition or change procedure, a SCG associated with a target PSCell is by default activated, and a connection to the target PSCell is successful if a UE random accesses to a new PSCell successfully. Besides, the UE may start timer T304 (as specified in 3GPP standard document TS38.331) upon a reception of a RRC message to add or change a target PSCell, or upon an execution of the (conditional) PSCell addition or change procedure. If timer T304 expires before the UE connects to the target PSCell successfully, the UE considers that the (conditional) PSCell addition or change procedure has failed.

The following table shows introductions of timer T304 as specified in 3GPP standard document TS38.331, including a start condition, a stop condition, and an operation at expiry. A possible general name for timer T304 may be “a handover timer” or the like.

| Timer | Start | Stop | At expiry |
|---|---|---|---|
| T304 | Upon reception of | Upon | For T304 of MCG, in case of the |
| | RRCReconfiguration | successful | handover from NR or intra-NR |
| | message including | completion of | handover, initiate the RRC |
| | reconfigurationWithSync | random access | re-establishment procedure. In |
| | or upon conditional | on the | case of handover to NR, perform |
| | reconfiguration | corresponding | the actions defined in the |
| | execution, i.e., when | SpCell. | specifications applicable for the |
| | applying a stored | For T304 of | source RAT. If any DAPS bearer |
| | RRCReconfiguration | SCG, upon | is configured and if there is no RLF |
| | message including | SCG release | in source PCell, initiate the failure |
| | reconfigurationWithSync. | | information procedure. |
| | | | For T304 of SCG, inform network |
| | | | about the reconfiguration with sync |
| | | | failure by initiating the SCG failure |
| | | | information procedure as specified |
| | | | in 5.7.3. |

In Release 17, during a (conditional) PSCell addition or change procedure, if a SCG associated with a target PSCell is set as deactivated, a UE might not need to perform a random access (RA) operation to the target SN. Specifically, once a UE applies configuration information of a target PSCell with a SCG associated with the target PSCell in a deactivated state, it implies that the UE successfully connects to the target PSCell even without the RA operation. After that, the UE will perform the RA operation to the target PSCell if the SCG associated with the target PSCell is activated. In this case, timer T304 cannot be directly used to determine whether the (conditional) PSCell addition or change procedure has failed. Thus, there is a need to solve an issue for handling timer T304 during a (conditional) PSCell addition or change procedure considering a deactivated state of a SCG associated with a target PSCell.

Currently, during a conditional PSCell change procedure, a UE will be configured with multiple candidate target PSCells (which can be of the same SN or a different SN), each PSCell is associated with an execution condition, and the UE connects to the target PSCell (which is one of the multiple candidate target PSCells) once the corresponding execution condition is fulfilled. Then, the UE releases the connection with the source PSCell. However, it could be less efficient, if the UE currently having traffic over an activated SCG changes to a target PSCell with a SCG deactivated. In this case, the UE or the network has to manually activate the SCG after the conditional PSCell change procedure. Thus, there is a need to solve the less efficient issue during the conditional PSCell change procedure considering a deactivated state of a SCG associated with a target PSCell.

Embodiments of the present application provide methods to support a (conditional) PSCell addition or change procedure considering a deactivated state of a SCG associated with a target PSCell. In some embodiments of the present application, if a SCG associated with a target PSCell is deactivated, upon a (conditional) PSCell addition or change procedure, timer T304 is not started, or timer T304 is stopped before its expiry, or timer T304 is ignored upon its expiry. Some embodiments of the present application introduce a new timer, to determine whether the (conditional) PSCell addition or change procedure is successfully completed if a SCG associated with a target PSCell is deactivated. In some embodiments of the present application, during a conditional PSCell change procedure, a UE considers a current state of a SCG associated with a target PSCell during selecting a target PSCell. More details will be illustrated in the following text in combination with the appended drawings.

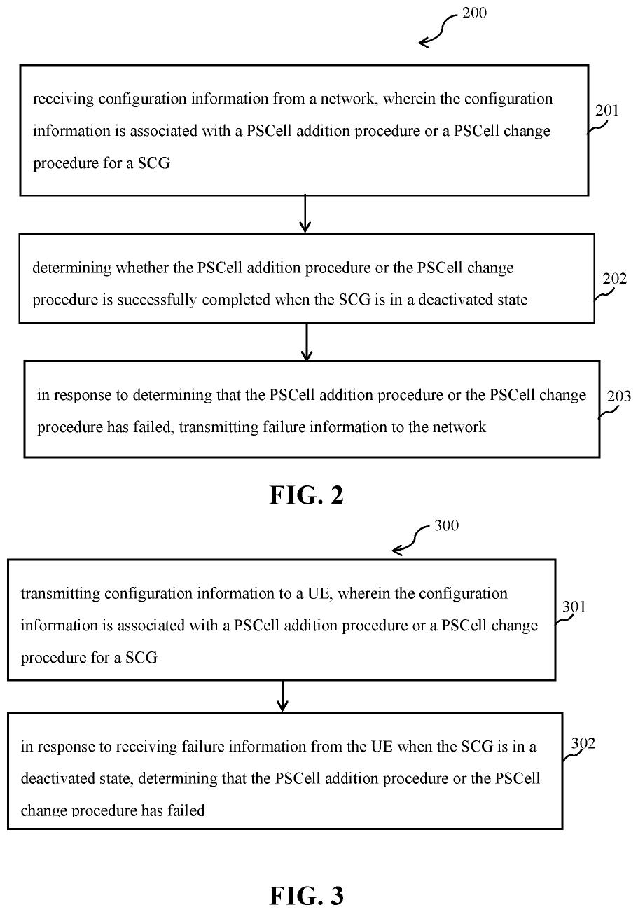

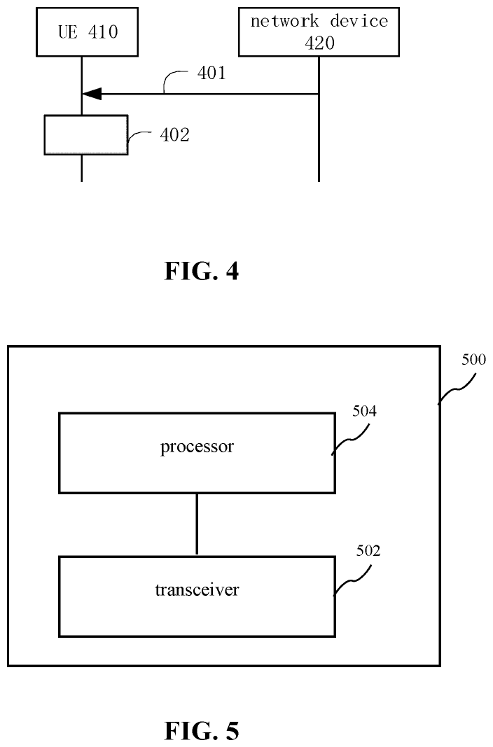

FIG. 2 illustrates an exemplary flow chart for receiving configuration information associated with a PSCell addition procedure or a PSCell change procedure in accordance with some embodiments of the present application. The exemplary method 200 in the embodiments of FIG. 2 may be performed by a UE (e.g., UE 101 or UE 410 as shown and illustrated in FIG. 1 or FIG. 4). Although described with respect to a UE, it should be understood that other devices may be configured to perform a method similar to that of FIG. 2.

In the exemplary method 200 as shown in FIG. 2, in operation 201, a UE (e.g., UE 101 as illustrated and shown in FIG. 1) receives configuration information from a network (e.g., a network device). The configuration information is associated with a PSCell addition procedure or a PSCell change procedure for a SCG. In operation 202, the UE determines whether the PSCell addition procedure or the PSCell change procedure is successfully completed when the SCG is in a deactivated state. In operation 203, in response to determining that the PSCell addition procedure or the PSCell change procedure has failed, the UE transmits failure information to the network.

According to some embodiments, the PSCell addition procedure may be a conditional PSCell addition procedure. According to some other embodiments, the PSCell addition procedure may be not a conditional PSCell addition procedure. According to some embodiments, the PSCell change procedure may be a conditional PSCell change procedure or not a conditional PSCell change procedure.

In some embodiments, if the PSCell change procedure is a conditional PSCell change procedure, the configuration information received in operation 201 includes a list of candidate PSCells. For example, each candidate PSCell in the list of candidate PSCells is associated with an execution condition of the conditional PSCell change procedure. Each candidate PSCell in the list of candidate PSCells is associated with a SCG, and the SCG may be in an activated state or a deactivated state.

In the embodiments of a conditional PSCell change procedure, the UE may select a target PSCell of the PSCell addition procedure or the PSCell change procedure from the list of candidate PSCells in the configuration information received in operation 201. The SCG in the PSCell addition procedure or the PSCell change procedure is associated with the target PSCell. For instance, the UE may select a target PSCell from candidate PSCell(s) within the list of candidate PSCells, and each candidate PSCell in the candidate PSCell(s) fulfils an execution condition of the conditional PSCell change procedure. When selecting the target PSCell from the candidate PSCell(s), the UE may consider a current state of a SCG associated with each candidate PSCell in the candidate PSCell(s). Details of these embodiments are described below.

In an embodiment, during selecting the target PSCell from the candidate PSCell(s), the UE determines a current state of a SCG associated with a source PSCell of the UE, and selects a candidate PSCell from the candidate PSCell(s) as the target PSCell, wherein a state of a SCG associated with the selected target PSCell is the same as the current state of the SCG associated with the source PSCell of the UE.

In a further embodiment, during selecting the target PSCell from the candidate PSCell(s), the UE determines a current state of a SCG associated with a source PSCell of the UE. If the UE determines that the current state of the SCG associated with the source PSCell of the UE is a deactivated state, the UE determines whether an activation procedure to the SCG associated with the source PSCell of the UE has been triggered. If the activation procedure to the SCG associated with the source PSCell of the UE has been triggered but not completed, the UE may select a candidate PSCell from the candidate PSCell(s) as the target PSCell, wherein a state of a SCG associated with the selected target PSCell is an activated state.

In another embodiment, during selecting the target PSCell from the candidate PSCell(s), the UE determines a current state of a SCG associated with a source PSCell of the UE. If the UE determines that the current state of the SCG associated with the source PSCell of the UE is an activated state, the UE determines whether a deactivation procedure to the SCG associated with the source PSCell of the UE has been triggered. If the deactivation procedure to the SCG associated with the source PSCell of the UE has been triggered but not completed, the UE may select a candidate PSCell from the candidate PSCell(s) as the target PSCell, wherein a state of a SCG associated with the selected target PSCell is a deactivated state.

According to some embodiments, if the (conditional) PSCell addition procedure or the PSCell change procedure to a target PSCell is triggered (i.e., upon an execution of the (conditional) PSCell addition or change procedure) and the SCG is associated with the target PSCell, the UE may start a handover timer (e.g., timer T304). If a RA operation to the target PSCell is successfully completed, the UE may stop the handover timer. In an embodiment, the configuration information received in operation 201 includes a length value of the handover timer (e.g., timer T304).

In some embodiments, if the SCG associated with the target PSCell is set to a deactivated state before an expiry of the handover timer (e.g., timer T304), the UE may stop the handover timer. In some further embodiments, if the SCG associated with the target PSCell is set to a deactivated state upon starting the handover timer, the UE may stop the handover timer after starting the handover timer. In some other embodiments, if the SCG associated with the target PSCell is set to an activated state upon triggering the PSCell addition procedure or the PSCell change procedure, and if the SCG associated with the target PSCell is deactivated before an expiry of the handover timer (e.g., timer T304) and before successfully completing the RA operation to the target PSCell, the UE may stop the handover timer.

According to some embodiments, if the SCG associated with the target PSCell is in a deactivated state upon an expiry of the handover timer (e.g., timer T304), and if a RA operation to the target PSCell is not triggered, there may be following two cases: (1) if the UE is in a downlink sync with the target PSCell, the UE may ignore the expiry of the handover timer; and (2) if the UE is not in the downlink sync with the target PSCell, the UE may determine that the PSCell addition procedure or the PSCell change procedure has failed and transmit the failure information to the network, and the failure information indicates a failure relating to the downlink sync with the target PSCell.

In an embodiment, the UE generates information about a SCG failure, and transmits the information about the SCG failure in operation 203. The SCG failure may include a failure relating to a downlink sync with a target PSCell, which may be marked as “a downlink sync failure” for short. For example, information about a SCG failure may be named as “SCG failure information” or the like. In some embodiments, in operation 203, the failure information may be transmitted to a network device (e.g., a MN) over a MCG in the network. In one example, upon an expiry of a time alignment timer (TAT), the UE generates SCG failure information and sends the generated SCG failure information to a MN over a MCG. In the SCG failure information, a new indicator may be used to indicate a downlink sync failure.

According to some embodiments, if an activation procedure to a SCG associated with a target PSCell has been triggered by the network or the UE, if the UE is in a downlink sync with the target PSCell, and if a RA operation to the target PSCell has been triggered but not completed, the UE may ignore the expiry of the handover timer (e.g., timer T304).

In some embodiments, if the UE receives, from the network, further configuration information regarding an activation procedure to a SCG associated with a target PSCell and/or if the UE triggers a RA operation to the target PSCell, the UE may determine that the activation procedure to the SCG associated with the target PSCell has been triggered by the network (e.g., a network device) or the UE.

According to some embodiments, if the PSCell addition procedure or the PSCell change procedure is triggered, and if the SCG associated with a target PSCell of the PSCell addition procedure or the PSCell change procedure is in a deactivated state, the UE does not start a handover timer (e.g., timer T304).

In an embodiment, if the UE does not start the handover timer, the UE determines or considers that the PSCell addition procedure or the PSCell change procedure is successfully completed. In a further embodiment, if the UE does not start the handover timer, the UE starts a further timer different from the handover timer. In following text, this further timer is marked as “Timer 1” for short. According to some embodiments, if the UE is in a downlink sync with the target PSCell and/or if a RA operation to the target PSCell is successfully completed, the UE may stop Timer 1.

In some embodiments, if Timer 1 expires, the UE may determine that the PSCell addition procedure or the PSCell change procedure has failed. In these embodiments, in response to determining that the PSCell addition procedure or the PSCell change procedure has failed, the UE may generate the failure information, which includes a failure cause of the PSCell addition procedure or the PSCell change procedure, and then transmit the generated failure information. In an embodiment, the failure information is information about a SCG failure (e.g., SCG failure information), and the SCG failure is a failure relating to a downlink sync of the UE with the target PSCell (i.e., a downlink sync failure). In an embodiment, in operation 203, the failure information is transmitted to a network device (e.g., a MN) over a MCG in the network.

In some embodiments, the UE receives configuration information regarding Timer 1 from the network. In an embodiment, the configuration information regarding Timer 1 is received via radio resource control (RRC) signalling. For example, the configuration information received in operation 201 includes the configuration information regarding Timer 1.

In an embodiment, the configuration information regarding Timer 1 may include: a state of the SCG associated with the target PSCell; and/or a length value of Timer 1. For instance, the length value of Timer 1 is at least greater than a time interval value between two synchronization signal block (SSB) transmissions. The time interval value between two SSB transmissions may be pre-configured as a default value or may be configured in a system information block (SIB) (e.g., SIB1).

Details described in all other embodiments of the present application (for example, details of handling a PSCell addition or change procedure considering a deactivated state of a SCG associated with a PSCell) are applicable for the embodiments of FIG. 2. Moreover, details described in the embodiments of FIG. 2 are applicable for all the embodiments of FIGS. 1 and 3-5.

FIG. 3 illustrates an exemplary flow chart for transmitting configuration information associated with a PSCell addition procedure or a PSCell change procedure in accordance with some embodiments of the present application. The exemplary method 300 in the embodiments of FIG. 3 may be performed by a network device (e.g., a MN and/or a SN). In some embodiments, the exemplary method 300 may be performed by MN 102, SN 103, or network device 420 as shown and illustrated in FIG. 1 or FIG. 4. Although described with respect to a network device (e.g., a MN and/or a SN), it should be understood that other devices may be configured to perform a method similar to that of FIG. 3. The embodiments of FIG. 3 assume that a MN and a SN may be combined in any one of EN-DC, NGEN-DC, NE-DC, and NR-DC scenarios.

In the exemplary method 300 as shown in FIG. 3, in operation 301, a network device (e.g., MN 102 and/or SN 103 as illustrated and shown in FIG. 1) transmits configuration information to a UE (e.g., UE 101 as illustrated and shown in FIG. 1). The configuration information is associated with a PSCell addition procedure or a PSCell change procedure for a SCG. In operation 302, in response to receiving failure information from the UE when the SCG is in a deactivated state, the network device determines that the PSCell addition procedure or the PSCell change procedure has failed.

According to some embodiments, the PSCell addition procedure is a conditional PSCell addition procedure. According to some other embodiments, the PSCell addition procedure is not a conditional PSCell addition procedure. According to some embodiments, the PSCell change procedure is a conditional PSCell change procedure. According to some other embodiments, the PSCell change procedure is not a conditional PSCell change procedure.

In some embodiments, if the PSCell change procedure is a conditional PSCell change procedure, the configuration information transmitted in operation 301 includes a list of candidate PSCells. In an embodiment, a target PSCell of the PSCell addition procedure or the PSCell change procedure is selected from the list of candidate PSCells in the configuration information transmitted in operation 301. The SCG in the PSCell addition procedure or the PSCell change procedure is associated with the selected target PSCell. For example, each candidate PSCell in the list of candidate PSCells is associated with an execution condition of the conditional PSCell change procedure. Each candidate PSCell in the list of candidate PSCells is associated with a SCG, and the SCG may be in an activated state or a deactivated state.

In an embodiment, the configuration information transmitted by the network device in operation 301 includes a length value of the handover timer (e.g., timer T304).

According to some embodiments, the network device transmits, to the UE, configuration information regarding an activation procedure to the SCG associated with a target PSCell of the PSCell addition procedure or the PSCell change procedure.

According to some embodiments, the network device transmits configuration information regarding Timer 1 to the UE. Timer 1 relates to the SCG in a deactivated state, and the SCG is associated with a target PSCell of the PSCell addition procedure or the PSCell change procedure. In an embodiment, the network device determines a state of the SCG associated with the target PSCell; and if the network device determines that the state of the SCG is a deactivated state, the network device transmits configuration information regarding Timer 1 (which relates to the SCG in the deactivated state) to the UE. For example, the configuration information regarding Timer 1 may be transmitted via RRC signalling. In an embodiment, the configuration information regarding Timer 1 is included in the configuration information transmitted in operation 301. In an embodiment, the configuration information regarding Timer 1 includes: a state of the SCG associated with the target PSCell; and/or a length value of Timer 1. The length value of Timer 1 may be at least greater than a time interval value between two SSB transmissions. The time interval value between two SSB transmissions is pre-configured as a default value or configured in a SIB (e.g., SIB1).

According to some embodiments, the failure information received by the network device includes a failure cause of the PSCell addition procedure or the PSCell change procedure. In these embodiments, in response to receiving the failure information, the network device may determine that the PSCell addition procedure or the PSCell change procedure has failed. According to some embodiments, if the network device does not receive the failure information, the network device determines that the PSCell addition procedure or the PSCell change procedure is successfully completed.

In an embodiment, the failure information is information about a SCG failure (e.g., SCG failure information), and the SCG failure is a failure relating to a downlink sync of the UE with the target PSCell (i.e., a downlink sync failure). In some embodiments, the failure information may be received by the network device (e.g., a MN) over a MCG in a network.

Details described in all other embodiments of the present application (for example, details of handling a PSCell addition or change procedure considering a deactivated state of a SCG associated with a PSCell) are applicable for the embodiments of FIG. 3. Moreover, details described in the embodiments of FIG. 3 are applicable for all the embodiments of FIGS. 1, 2, 4, and 5.

FIG. 4 illustrates an exemplary flow chart relating to configuration information associated with a PSCell addition procedure or a PSCell change procedure in accordance with some embodiments of the present application.

As shown in FIG. 4, in operation 401, UE 410 (e.g., UE 101 as illustrated and shown in FIG. 1) receives configuration information from network device 420 (e.g., MN 102 and/or SN 103 as illustrated and shown in FIG. 1). The configuration information is associated with a (conditional) PSCell addition procedure or a (conditional) PSCell change procedure. That is, UE 410 is configured by network device 420 to perform a (conditional) PSCell addition or change procedure.

In operation 402 as shown in FIG. 4, there may be following specific Embodiments 1-4 as described below.

### EMBODIMENT 1

In Embodiment 1, UE 410 may start timer T304 upon an execution of the (conditional) PSCell addition or change procedure. For example, UE 410 starts timer T304 upon a reception of RRCReconfiguration message including reconfigurationWithSync or upon an execution of conditional reconfiguration (i.e., when applying a stored RRCReconfiguration message including reconfigurationWithSync). After timer T304 starts, UE 410 may stop timer T304 or may act in response to an expiry of timer T304 considering an activated state or a deactivated state of a SCG which is associated with a target PSCell of the (conditional) PSCell addition or change procedure. The SCG associated with the target PSCell may a named as “a target SCG” or the like.

In Embodiment 1, timer T304 may be stopped when a RA operation to the target PSCell happens, or timer T304 may run until its expiry, or timer T304 runs until UE 410 successfully completes the RA operation to the target PSCell. Upon an expiry of timer T304, UE 410 may behave as follows depending on what has happened before the expiry of timer T304:
(1) If the target SCG remains in a deactivated state, if UE 410 has not attempted to random access the target PSCell, and if UE 410 is downlink synced with the target PSCell, UE 410 may ignore the expiry of timer T304 (i.e., UE 410 does nothing).
(2) If the target SCG remains deactivated, if UE 410 has not attempted to random access the target PSCell, but UE 410 is not downlink synced with the target PSCell, UE 410 may inform network device 420 about a failure relating to the (conditional) PSCell addition or change procedure due to a downlink sync failure. In one example, upon an expiry of a TAT, UE 410 generates SCG failure information and sends the generated SCG failure information to a MN over a MCG. In the generated SCG failure information, a new indicator may be used to indicate the downlink sync failure.
(3) If an activation procedure to the target SCG is triggered by network device 420 (e.g., UE 410 receives SCG activation configuration from a MN) or UE 410 (e.g., UE 410 starts a RA operation to the target PSCell), if UE 410 is downlink synced with the target PSCell, and if the random access to the PSCell has not completed yet, UE 410 may ignore the expiry of timer T304 (i.e., UE 410 does nothing).

In Embodiment 1, timer T304 may be stopped immediately if the target SCG is set to a deactivated state before the expiry of timer T304. In one example, the target SCG of the target PSCell is provided to be a deactivated state, and timer T304 is stopped immediately after timer T304 is started. In another example, the target SCG of the target PSCell is set to be an activated state when UE 410 executes the (conditional) PSCell addition or change procedure. However, before the expiry of timer T304 and before UE 410 successfully random accesses to the target PSCell, if UE 410 receives another message from network device 420 to deactivate the target SCG, UE 410 may stop timer T304.

### EMBODIMENT 2

In Embodiment 2, when UE 410 is configured by network device 420 to perform a (conditional) PSCell addition or change procedure, if a target SCG of a target PSCell is set to be deactivated, UE 410 does not start timer T304 upon an execution of the (conditional) PSCell addition or change procedure (e.g., upon a reception of RRCReconfiguration message including reconfigurationWithSync or upon conditional reconfiguration execution (e.g., when applying a stored RRCReconfiguration message including reconfigurationWithSync)). In Embodiment 2, if timer T304 is not started, UE 410 does not consider the (conditional) PSCell addition or change procedure as failed. That is, in Embodiment 2, UE 410 assumes that the (conditional) PSCell addition or change procedure is successful.

### EMBODIMENT 3

In Embodiment 3, when UE 410 is configured by network device 420 to perform a (conditional) PSCell addition or change procedure, if a target SCG of the target PSCell is set to be deactivated, a new timer (e.g., Timer 1) is started upon an execution of the (conditional) PSCell addition or change procedure (i.e., upon a reception of RRCReconfiguration message including reconfigurationWithSync or upon conditional reconfiguration execution (i.e., when applying a stored RRCReconfiguration message including reconfigurationWithSync)).

In Embodiment 3, a length value of the new timer (e.g., Timer 1) is at least enough for UE 410 to be downlink synced with the target PSCell. For example, a length value of Timer 1 is at least greater than a time interval value between two SSB transmissions. The time interval value between two SSB transmissions may be pre-configured as a default value (e.g., 20 ms), or may be configured in the first SIB, i.e., SIBI (e.g., 5 ms, 10 ms, 20 ms, 40 ms, 80 ms, 160 ms, or other possible value).

In Embodiment 3, the new timer (e.g., Timer 1) is stopped in case of any (combination) of the following:
(1) UE 410 is successfully downlink synced with the target PSCell;
(2) UE 410 successfully random accesses to the target PSCell. For example, UE 410 may start a RA operation when an SCG activation procedure is triggered by network device 420 (e.g., upon UE 410 receiving SCG activation configuration from a MN) or UE 410 (e.g., upon UE 410 starting a RA operation to the target PSCell).

In Embodiment 3, if the new timer (e.g., Timer 1) expires, UE 410 may determines or considers that the (conditional) PSCell addition or change procedure has failed, and UE 410 may generate SCG failure information and send the SCG failure information to a MN over a MCG. A failure cause may be indicated in the SCG failure information, e.g., UE 410 is not downlink synced with the target PSCell.

In Embodiment 3, the new timer (e.g., Timer 1) can be configured by dedicated RRC signalling nested in CellGroupConfig information element (IE) as specified in 3GPP standard document TS38.331. One specific example is given below, wherein the SpCellState indicates whether the SCG associated with the target PSCell is activated or deactivated, and if the SCG is deactivated, the new timer provided inside ReconfiguratoinWithSync will be used. As shown below, a length value of the new timer is enumerated as {ms50, ms100}, i.e., 50 ms and 100 ms.

CellGroupConfig information element

| | |
|---|---|
| SpCellConfig ::= | SEQUENCE { |
| servCellIndex | ServCellIndex |

OPTIONAL, -- Cond SCG

| | |
|---|---|
| SpcellState | ENUMERATED {activated, deactivated} |
| reconfigurationWithSync | ReconfigurationWithSync |

OPTIONAL, -- Cond ReconfWithSync

| | |
|---|---|
| rlf-TimersAndConstants | SetupRelease |
| { RLF-TimersAndConstants } | OPTIONAL, -- Need M |
| rlmInSyncOutOfSyncThreshold | ENUMERATED {n1} |

OPTIONAL, -- Need S

| | |
|---|---|
| spCellConfigDedicated | ServingCellConfig |

OPTIONAL, -- Need M
...
}

| | |
|---|---|
| ReconfigurationWithSync ::= | SEQUENCE { |
| spCellConfigCommon | ServingCellConfigCommon |

OPTIONAL, -- Need M

| | |
|---|---|
| newUE-Identity | RNTI-Value, |
| t304 | ENUMERATED {ms50, ms100, |

ms150, ms200, ms500, ms1000, ms2000, ms10000},

| | |
|---|---|
| new timer | ENUMERATED {ms50, ms100}, |
| rach-ConfigDedicated | CHOICE { |
| uplink | RACH-ConfigDedicated, |
| supplementaryUplink | RACH-ConfigDedicated |

```
    }
OPTIONAL, -- Need N
    ...,
    [[
```

| | |
|---|---|
| smtc | SSB-MTC |

```
OPTIONAL -- Need S
    ]],
    [[
```

| | |
|---|---|
| daps-UplinkPowerConfig-r16 | DAPS-UplinkPowerConfig-r16 |

OPTIONAL -- Need N
]]
}

### EMBODIMENT 4

In Embodiment 4, during a conditional PSCell change procedure, UE 410 may be provided with a list of candidate PSCell(s). Each candidate PSCell within the list is associated with a SCG which may be in an activated state or a deactivated state. Each candidate PSCell within the list is associated with an execution condition. When two or more candidate PSCells fulfil their execution condition(s), UE 410 may select a target PSCell from the two or more candidate PSCells fulfilling their execution condition(s) by considering the current state of the SCG. A state of a SCG may also be named as “a SCG state” or the like.

In Embodiment 4, UE 410 may prioritize selecting the target PSCell with a SCG of the same state as a current SCG state of UE 410. In one example, if the SCG associated with a source PSCell of UE 410 is deactivated or activated, UE 410 shall select the target PSCell with SCG deactivated or activated from the two or more candidate PSCells fulfilling their execution condition(s).

In Embodiment 4, if the current SCG state is deactivated, and the SCG activation procedure has been triggered but not completed yet, e.g., if the SCG activation procedure is triggered by network device 420 (e.g., UE 410 receives SCG activation configuration from a MN) or UE 410 (e.g., UE 410 starts a RA operation to the target PSCell), UE 410 may select the target PSCell with SCG activated from the candidate PSCells fulfilling their execution condition(s).

In Embodiment 4, if the current SCG state is activated, and the SCG deactivation procedure has been triggered but not completed yet, e.g., if the SCG deactivation procedure is triggered by network device 420 (e.g., UE 410 receives SCG activation configuration from a MN) or UE 410 (e.g., UE 410 starts a RA operation to the target PSCell), UE 410 shall select the target PSCell with SCG deactivated from the candidate PSCells fulfilling their execution condition(s).

Details described in all other embodiments of the present application (for example, details of handling a PSCell addition or change procedure considering a deactivated state of a SCG associated with a PSCell) are applicable for the embodiments of FIG. 4. Moreover, details described in the embodiments of FIG. 4 are applicable for all the embodiments of FIGS. 1-3 and 5.

FIG. 5 illustrates an exemplary block diagram of an apparatus according to some embodiments of the present application. As shown in FIG. 5, the apparatus 500 may include at least one processor 504 and at least one transceiver 502 coupled to the processor 504. The apparatus 500 may be a UE or a network device (e.g., a MN and/or a SN).

Although in this figure, elements such as the at least one transceiver 502 and processor 504 are described in the singular, the plural is contemplated unless a limitation to the singular is explicitly stated. In some embodiments of the present application, the transceiver 502 may be divided into two devices, such as a receiving circuitry and a transmitting circuitry. In some embodiments of the present application, the apparatus 500 may further include an input device, a memory, and/or other components.

In some embodiments of the present application, the apparatus 500 may be a UE. The transceiver 502 in the UE may be configured to receive configuration information from a network, wherein the configuration information is associated with a PSCell addition procedure or a PSCell change procedure for a SCG. The processor 504 in the UE may be configured: to determine whether the PSCell addition procedure or the PSCell change procedure is successfully completed when the SCG is in a deactivated state; and in response to determining that the PSCell addition procedure or the PSCell change procedure has failed, to transmit failure information to the network via the wireless transceiver.

In some embodiments of the present application, the apparatus 500 may be a network device (e.g., a MN and/or a SN). The transceiver 502 in the network device may be configured to transmit configuration information to a UE, wherein the configuration information is associated with a PSCell addition procedure or a PSCell change procedure for a SCG. In response to receiving, via the wireless transceiver, failure information from the UE when the SCG is in a deactivated state, the processor 504 in the network device may be configured to determine that the PSCell addition procedure or the PSCell change procedure has failed.

In some embodiments of the present application, the apparatus 500 may further include at least one non-transitory computer-readable medium. In some embodiments of the present disclosure, the non-transitory computer-readable medium may have stored thereon computer-executable instructions to cause a processor to implement the method with respect to a UE or a network device (e.g., a MN and/or a SN) as described above. For example, the computer-executable instructions, when executed, cause the processor 504 interacting with transceiver 502, so as to perform operations of the methods, e.g., as described in view of any of FIGS. 2-4.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE) comprising:
a processor; and
a memory coupled with the processor, the processor configured to cause the UE to:
receive first configuration information from a network, wherein the first configuration information is associated with a primary secondary cell (PSCell) addition procedure or a PSCell change procedure for a secondary cell group (SCG);
determine whether the PSCell addition procedure or the PSCell change procedure is successfully completed when the SCG is in a deactivated state; and
in response to determining that the PSCell addition procedure or the PSCell change procedure has failed, transmit failure information to the network.

2. The UE of claim 1, wherein:
in response to the PSCell change procedure being a conditional PSCell change procedure, the first configuration information includes a list of candidate PSCells; and
wherein the processor is further configured to cause the UE to select a target PSCell of the PSCell addition procedure or the PSCell change procedure from the list of candidate PSCells, wherein the SCG is associated with the target PSCell.

3. The UE of claim 2, wherein the processor is further configured to cause the UE to select the target PSCell by selecting the target PSCell from one or more candidate PSCells within the list of candidate PSCells, and wherein each candidate PSCell in the one or more candidate PSCells fulfills an execution condition of the conditional PSCell change procedure.

4. The UE of claim 3, wherein the processor is further configured to cause the UE to select the target PSCell from the one or more candidate PSCells by considering a current state of a SCG associated with each candidate PSCell in the one or more candidate PSCells.

5. The UE of claim 4, wherein the processor is configured to cause the UE to select the target PSCell from the one or more candidate PSCells by:
determining a current state of a SCG associated with a source PSCell of the UE; and
selecting a candidate PSCell from the one or more candidate PSCells as the target PSCell, wherein a state of a SCG associated with the selected target PSCell is the same as the current state of the SCG associated with the source PSCell of the UE.

6. The UE of claim 1, wherein the processor is further configured to cause the UE to:
in response to triggering the PSCell addition procedure or the PSCell change procedure to a target PSCell, start a handover timer, wherein the SCG is associated with the target PSCell of the PSCell addition procedure or the PSCell change procedure; and
in response to successfully completing a random access (RA) operation to the target PSCell, stop the handover timer.

7. The UE of claim 6, wherein the processor is further configured to cause the UE to:
in response to the SCG associated with the target PSCell being set to the deactivated state before an expiry of the handover timer, stop the handover timer.

8. The UE of claim 6, wherein the processor is further configured to cause the UE to:
in response to the SCG associated with the target PSCell in the deactivated state upon an expiry of the handover timer, and in response to not triggering the RA operation to the target PSCell:
in response to the UE in a downlink sync with the target PSCell, ignore the expiry of the handover timer; and
in response to the UE not in the downlink sync with the target PSCell, determine that the PSCell addition procedure or the PSCell change procedure has failed and transmit the failure information to the network, wherein the failure information indicates a failure relating to the downlink sync with the target PSCell; and
in response to an activation procedure to the SCG associated with the target PSCell having been triggered by the network or the UE, in response to the UE in a downlink sync with the target PSCell, and in response to the RA operation to the target PSCell having been triggered but not completed, ignore the expiry of the handover timer.

9. The method of claim 1, wherein the processor is further configured to cause the UE to:
in response to triggering the PSCell addition procedure or the PSCell change procedure and in response to the SCG is in the deactivated state, not start a handover timer, wherein the SCG is associated with a target PSCell of the PSCell addition procedure or the PSCell change procedure.

10. The UE of claim 9, wherein the processor is further configured to cause the UE to:
in response to not starting the handover timer, start a second timer, wherein the second timer is different from the handover timer.

11. The UE of claim 10, wherein the processor is further configured to cause the UE to:
stop the second timer, in response to at least one of:
the UE in a downlink sync with the target PSCell; and
successfully completing a RA operation to the target PSCell.

12. The UE of claim 10, wherein the processor is further configured to cause the UE to:
in response to an expiry of the second timer, determining determine that the PSCell addition procedure or the PSCell change procedure has failed.

13-14. (canceled)

15. A network device, comprising:
a processor; and
a memory coupled with the processor, the processor configured to cause the network device to:
transmit, via the wireless transceiver, configuration information to a user equipment (UE), wherein the configuration information is associated with a primary secondary cell (PSCell) addition procedure or the PSCell change procedure for a secondary cell group (SCG); and
in response to receiving, via the wireless transceiver, failure information from the UE when the SCG is in a deactivated state, determine that the PSCell addition procedure or the PSCell change procedure has failed.

16. A method performed by a user equipment (UE), the method comprising:
receiving first configuration information from a network, wherein the first configuration information is associated with a primary secondary cell (PSCell) addition procedure or a PSCell change procedure for a secondary cell group (SCG);
determining whether the PSCell addition procedure or the PSCell change procedure is successfully completed when the SCG is in a deactivated state; and
in response to determining that the PSCell addition procedure or the PSCell change procedure has failed, transmitting failure information to the network.

17. The method of claim 16, wherein, in response to the PSCell change procedure being a conditional PSCell change procedure, the first configuration information includes a list of candidate PSCells, the method further comprising:
selecting a target PSCell of the PSCell addition procedure or the PSCell change procedure from the list of candidate PSCells, wherein the SCG is associated with the target PSCell.

18. The method of claim 16, wherein, in response to triggering the PSCell addition procedure or the PSCell change procedure to a target PSCell, startting a handover timer, wherein the SCG is associated with the target PSCell of the PSCell addition procedure or the PSCell change procedure; and, in response to successfully completing a random access (RA) operation to the target PSCell, stopping the handover timer.

19. The method of claim 16, further comprising:
in response to triggering the PSCell addition procedure or the PSCell change procedure and in response to the SCG is in the deactivated state, not starting a handover timer, wherein the SCG is associated with a target PSCell of the PSCell addition procedure or the PSCell change procedure.

20. A processor for wireless communication, comprising:
at least one controller coupled with at least one memory and configured to cause the processor to:
receive first configuration information from a network, wherein the first configuration information is associated with a primary secondary cell (PSCell) addition procedure or a PSCell change procedure for a secondary cell group (SCG);
determine whether the PSCell addition procedure or the PSCell change procedure is successfully completed when the SCG is in a deactivated state; and
in response to determining that the PSCell addition procedure or the PSCell change procedure has failed, transmit failure information to the network.

21. The processor of claim 20, wherein:
in response to the PSCell change procedure being a conditional PSCell change procedure, the first configuration information includes a list of candidate PSCells; and
wherein the processor is further configured to cause the UE to select a target PSCell of the PSCell addition procedure or the PSCell change procedure from the list of candidate PSCells, wherein the SCG is associated with the target PSCell.

22. The processor of claim 21, wherein the processor is further configured to cause the UE to select the target PSCell by selecting the target PSCell from one or more candidate PSCells within the list of candidate PSCells, and wherein each candidate PSCell in the one or more candidate PSCells fulfills an execution condition of the conditional PSCell change procedure.
